(19) United States
(12) Patent Application Publication
(10) Pub. No.: US 2014/0218513 A1
(43) Pub. Date: Aug. 7, 2014

(54) REMOTE DEVICE FOR CHANGING THE DISPLAY CONTENT OF THE DISPLAY MODULE IN A SURVEILLANCE CAMERA

(71) Applicant: G-STAR INTERNATIONAL TELECOMMUNICATION CO., LTD, Taipei City (TW)

(72) Inventor: Min-Chieh Hsu, Taipei City (TW)

(73) Assignee: G-STAR INTERNATIONAL TELECOMMUNICATION CO., LTD, Taipei City (TW)

(21) Appl. No.: 13/761,617

(22) Filed: Feb. 7, 2013

(51) Int. Cl. H04N 7/18

(52) U.S. Cl. CPC H04N 7/18
USPC 348/143

(57) ABSTRACT

A remote device for changing the display content of the display module in a surveillance camera includes at least one surveillance camera, at least one side of each surveillance camera having a display module, each display module electrically connected to a video/audio control circuit. The video/audio control circuit is electrically connected to a display control module of a digital video/audio storage device via a screen transmission line. The display control module has a port for connecting an input device, thereby the display content shown on the display module can be changed by the data input from the input device.

### BACKGROUND OF THE INVENTION

1. Field of the invention

This invention is related to a remote device for changing the display content of the display module in a surveillance camera, and more particular to a remote input device used to modify the display content via a transmission line, wherein the display content is transmitted to a display module in a surveillance camera and the modified display content is displayed via the display module.

2. Description of Related Art

Conventional surveillance cameras are commonly mounted on the streets, banks, convenience stores and military bases, etc., which has the capabilities of image recording and real-time monitoring. However, the main purpose of the conventional surveillance camera is to prevent crime and to provide criminal verification, which is not only helpful to solve a criminal case, but also reduce the crime rate. It is to be noted that the surveillance camera is important to the society.

Normally, a simple conventional surveillance camera mounted in a specific location, such as: restaurant, supermarkets, etc., is used for monitoring only. If the surveillance camera can provide the guests with congratulations, or provide the offenders with warnings, the surveillance camera will attract crowds or reduce the crime rate. In addition, the appearance of the conventional surveillance camera is hard to distinguish whether the surveillance camera is out of order. For this reason, the conventional surveillance camera needs to be improved.

Further, the structure of a conventional surveillance camera as shown in FIG. 1, includes: a camera 1 electrically connected to a power supply 12, so that the power supply 12 can provide power to the circuit board 11 of the camera 1; and a display 13 located at at least one side of the camera 1. The display 13 is electrically connected to the circuit board 11 of the camera 1 so that the display 13 shows text or pattern in accordance with the control signals of the control circuit 111 of the circuit board 11.

However, if someone needs to change the display content of the conventional surveillance camera, the conventional surveillance camera needs to be taken down from a high place to change the display content thereof. It is very inconvenient and rather cumbersome.

Therefore, the conventional surveillance camera still has many defects, which are necessary to be improved.

### SUMMARY OF THE INVENTION

The first objective of the present invention is to provide a device for remotely changing display content of a display module in a surveillance camera so that the display content of the display module can be easily and rapidly changed.

In order to solve the above mentioned deficiency and achieve the objective of the present invention, the present invention provides a device for remotely changing display content of a display module in a surveillance camera, including: at least one surveillance camera having a lens, a display module, an audio/video control circuit and a power supply module, wherein the lens and the display module are electrically connected to the audio/video control circuit respectively, a digital audio/video storage device having a host control circuit and a display control module, wherein the display control module has a port having two ends, one end of the port electrically connected to the display control module, and the other end of the port electrically connected to an input device. At least one first transmission line has two ends, one end thereof electrically connected to the audio/video control circuit of the at least one surveillance camera, the other end thereof electrically connected to the host control circuit of the digital audio/video storage device, and a second transmission line has two ends, one end thereof electrically connected to the audio/video control circuit of the at least one surveillance camera, the other end thereof electrically connected to the display control module of the digital audio/video storage device, wherein the display content displayed on the display module can be changed by data input from the input device.

Preferably, at least one side of the surveillance camera has at least one light-emitting element.

Preferably, the port is one selected from the following group consisting of: USB slot, PS2 slot, dual slots and triple slots.

Preferably, the input device is one selected from the following group consisting of: mobile phones, computers, personal digital assistants (PDAs), mouse, and keyboard.

Preferably, the display module is one selected from the following group consisting of: a LCD screen, an OLED display screen, an LED display screen.

Preferably, the display content is one selected from the following group consisting of: text, graphics, text and graphics.

According to the above objective, the present invention further proposes a device for remotely changing display content of a display module in a surveillance camera, including: at least one surveillance camera having a lens, a display module, an audio/video control circuit and a power supply module, wherein the lens and the display module are electrically connected to the audio/video control circuit respectively, the audio/video control circuit having a radio transceiver circuit so as to transmit image signals captured by the lens and receive an input data via the radio transceiver circuit, a digital audio/video storage device having a host control circuit and a display control module, wherein the host control circuit has a radio receiver circuit for receiving image signals from the audio/video control circuit, and the display control module has a port with two ends, one end of the port electrically connected to the display control module and the other end of the port electrically connected to an input device. The display control module has a radio transmitter circuit for transmitting display data input by the input device to the radio transceiver circuit of the audio/video control circuit, wherein the display content displayed on the display module can be changed by data input from the input device via radio transmission.

Preferably, at least one side of the surveillance camera has at least one light-emitting element.

Preferably, the port is one selected from the following group consisting of: USB slot, PS2 slot, dual slots and triple slots.

Preferably, the input device is one selected from the following group consisting of: mobile phones, computers, personal digital assistants (PDAs), mouse, and keyboard.

According to the above objective, the present invention additionally proposes a device for remotely changing display content of a display module in a surveillance camera, including: at least one surveillance camera having a lens, a display module, an audio/video control circuit and a power supply module, wherein the lens and the display module are electrically connected to the audio/video control circuit respectively, a computer having a motherboard and an audio/video storage control interface, the audio/video storage control interface electrically connected to the motherboard, and at least one transmission line having two ends, one end thereof electrically connected to the audio/video control circuit of the at least one surveillance camera, the other end thereof electrically connected to the audio/video storage control interface of the computer, wherein the display content displayed on the display module can be changed by data input from the input device of the computer.

Preferably, at least one side of the surveillance camera has at least one light-emitting element.

Comparing to the prior art, the present invention has the following advantages and efficacy:

The first technical means in the present invention is to set a display control module in the digital audio/video storage devices to be connected to an input device via the port set in the display control module, so that the display contents of the display module can be changed by a display data via a screen transmission line and the audio/video control circuit.

Therefore, no one is needed to go climbing to a high location to remove the surveillance cameras one by one, and the display contents of the display module in the surveillance cameras mounted on high locations can be changed more rapidly and conveniently.

The second technical means in the present invention is to set a display control module in the digital audio/video storage devices to be connected to an input device via the port set in the display control module, so that the display contents of the display module can be changed by a display data via a radio transceiver circuit in the audio/video control circuit.

This method is different from the first technical means, achieving the objective of changing the display content of the display module, and avoiding the disturbance of the transmission line by mounting a multiplicity of surveillance cameras.

The third technical means in the present invention is to set a audio/video storage control interface inside a computer. The audio/video storage control interface is electrically connected to a motherboard inside the computer and an input device outside the computer. The display contents of the display module can be changed by a display data via a data transmission line and the audio/video control circuit.

This method is different from the first technical means. Since the digital audio/video storage device (DVR) is set inside the PC, and the data transmission line can pass the display data to change the display content of the display module via the audio/video control circuit, and also transmit the image data captured by the lens to the audio/video control interface via the audio/video circuit; and then to the mother board via the audio/video control interface. To be briefly, the data transmission line has bi-directional transmission function.

### BRIEF DESCRIPTION OF THE DRAWINGS

The invention, as well as its many advantages, may be further understood by the following detailed description and drawings in which:

FIG. 1 is a schematic perspective view of the conventional structure of a surveillance camera; and

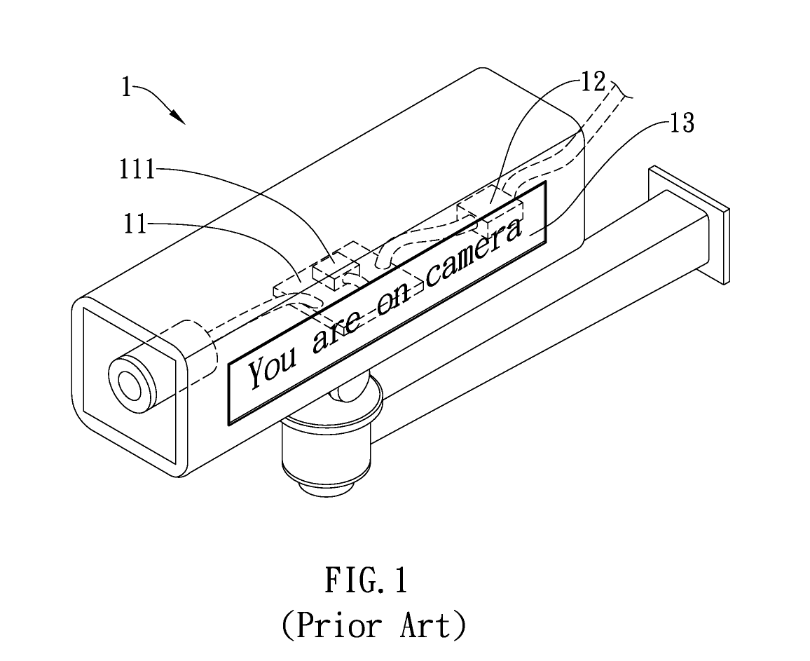

FIG. 2 is a schematic perspective view of the first embodiment of the present invention.

FIG. 3 is a schematic perspective view of the second embodiment of the present invention.

FIG. 4 is a block flow chart showing the first embodiment of the present invention.

FIG. 5 is a schematic perspective view of the third embodiment of the present invention.

FIG. 6 is a block flow chart showing the third embodiment of the present invention.

### DETAILED DESCRIPTION OF THE INVENTION

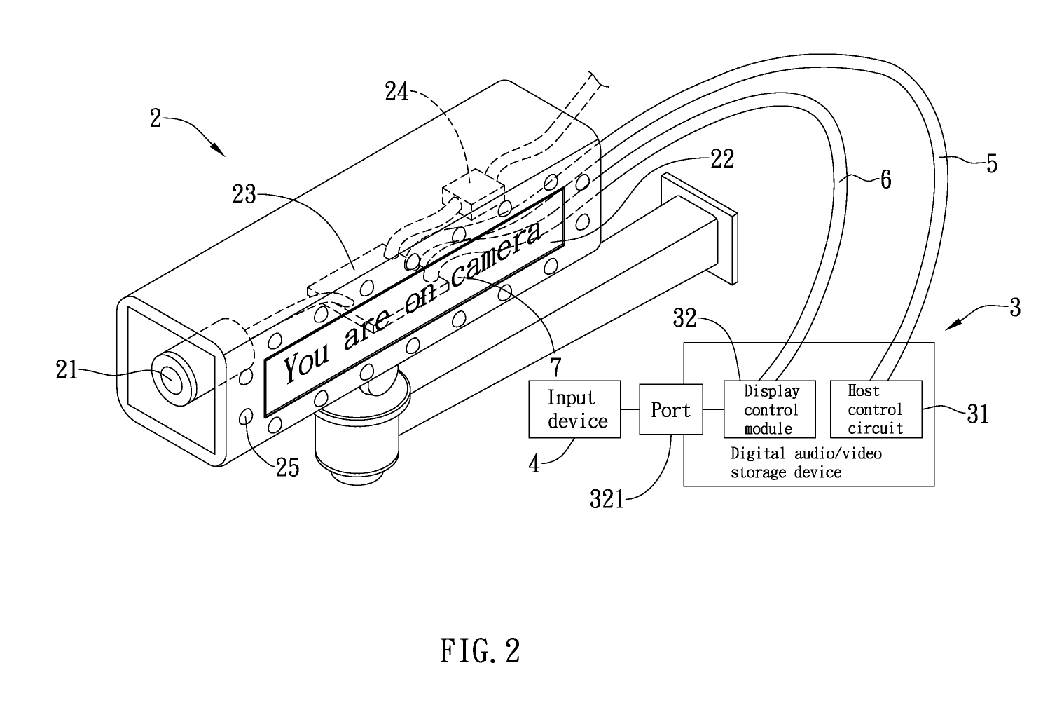

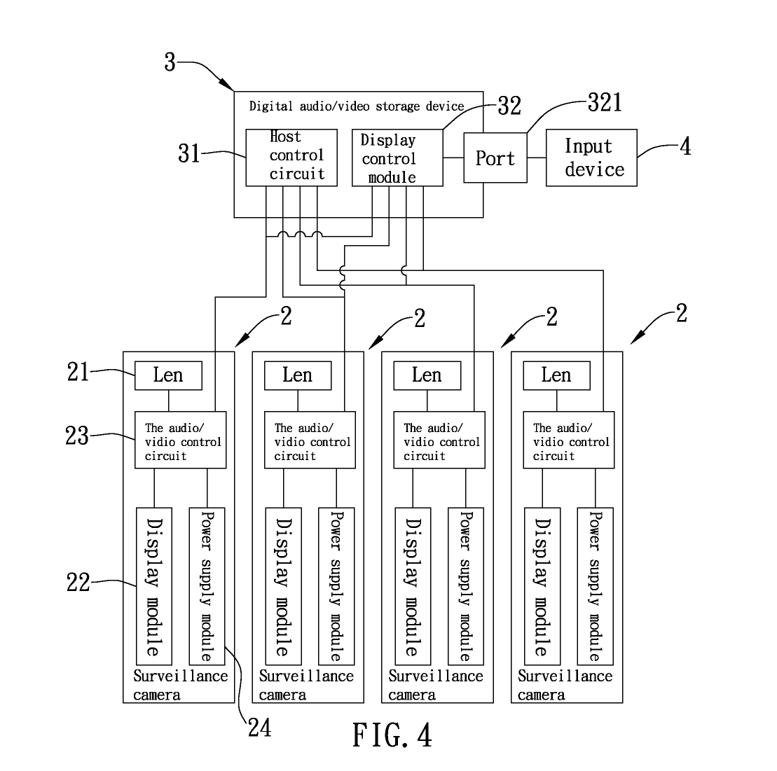

In a first embodiment, as shown in FIG. 2 and FIG. 4, FIG. 2 is a schematic perspective view of the first embodiment of the present invention, FIG. 4 is a block flow chart showing the first embodiment of the present invention.

As shown in the figures, the device for remotely changing display content of a display module in a surveillance camera, comprising:

at least one surveillance camera 2 having a lens 21, a display module 22, an audio/video control circuit 23 and a power supply module 24, wherein the lens 21 and the display module 22 are electrically connected to the audio/video control circuit 23 respectively;

a digital audio/video storage device 3 having a host control circuit 31 and a display control module 32, wherein the display control module 32 has a port 321 having two ends, one end of the port 321 electrically connected to the display control module 32, and the other end of the port electrically connected to an input device 4;

at least one first transmission line 5 having two ends, one end thereof electrically connected to the audio/video control circuit 23 of the at least one surveillance camera 2, the other end thereof electrically connected to the host control circuit 31 of the digital audio/video storage device 3; and

a second transmission line 6 having two ends, one end thereof electrically connected to the audio/video control circuit 23 of the at least one surveillance camera 2, the other end thereof electrically connected to the display control module 32 of the digital audio/video storage device 3,

wherein, the display content 7 displayed on the display module 22 can be changed by data input from the input device 4.

Wherein, the display content 7 is one selected from the following group consisting of: text (such as “WELCOME” or “Please smile, you are on camera”), graphics, text and graphics. The display content 7 can be changed accordance with different situation and mounting location of the surveillance camera 2.

Wherein, at least one side of the surveillance camera 2 has at least one light-emitting element 25 so as to reach the purpose of light emitting, high lighting and easily repairing.

Wherein, the input device 4 is one selected from the following group consisting of: mobile phones, computers, personal digital assistants (PDAs), mouse, and keyboard. Therefore, the display content 7 of the display module 22 can be easily and rapidly changed by the input device 4.

Wherein, the port 321 is one selected from the following group consisting of: USB slot, PS2 slot, dual slots and triple slots, so that the port 321 can be electrically connected to different input device 4 for inputting the changed display data.

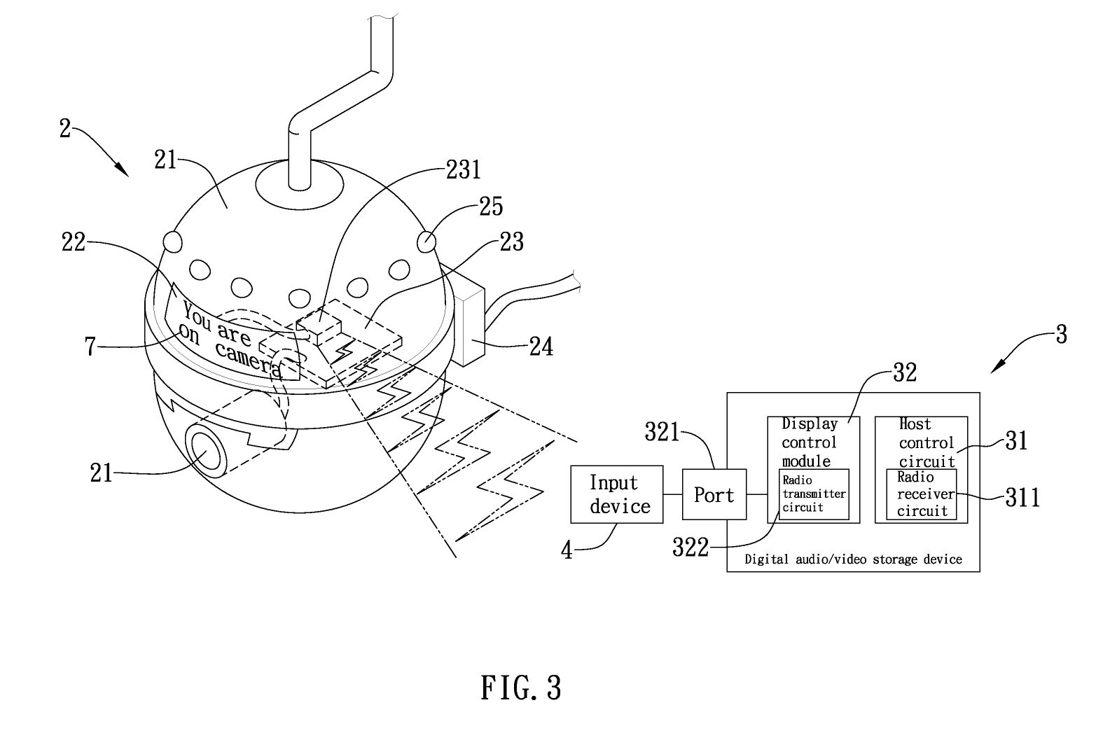

In a second embodiment, as shown in FIG. 3, FIG. is a device for remotely changing display content of a display module in a surveillance camera, including:

at least one surveillance camera 2 having a lens 21, a display module 22, an audio/video control circuit 23 and a power supply module 24, wherein the lens 21 and the display module 22 are electrically connected to the audio/video control circuit 23 respectively, the audio/video control circuit 23 having a radio transceiver circuit 231 so as to transmit image signals captured by the lens 21 and receive an input data via the radio transceiver circuit 231;

a digital audio/video storage device 3 having a host control circuit 31 and a display control module 32, wherein the host control circuit 31 has a radio receiver circuit 311 for receiving image signals from the audio/video control circuit 23, and the display control module 32 having a port 321 with two ends, one end of the port 321 electrically connected to the display control module 32 and the other end of the port 321 electrically connected to an input device 4, the display control module 32 having a radio transmitter circuit 322 for transmitting display data input by the input device 4 to the radio transceiver circuit 321 of the audio/video control circuit 23, wherein, the display content 7 displayed on the display module 22 can be changed by data input from the input device via the radio transmission.

Wherein, at least one side of the surveillance camera 2 has at least one light-emitting element 25 so as to reach the purpose of light emitting, high lighting and easily repairing.

Wherein, the input device 4 is one selected from the following group consisting of: mobile phones, computers, personal digital assistants (PDAs), mouse, and keyboard. Therefore, the display content 7 of the display module 22 can be easily and rapidly changed by the input device 4.

Wherein, the port 321 is one selected from the following group consisting of: USB slot, PS2 slot, dual slots and triple slots, so that the port 321 can be electrically connected to different input device 4 for inputting the changed display data.

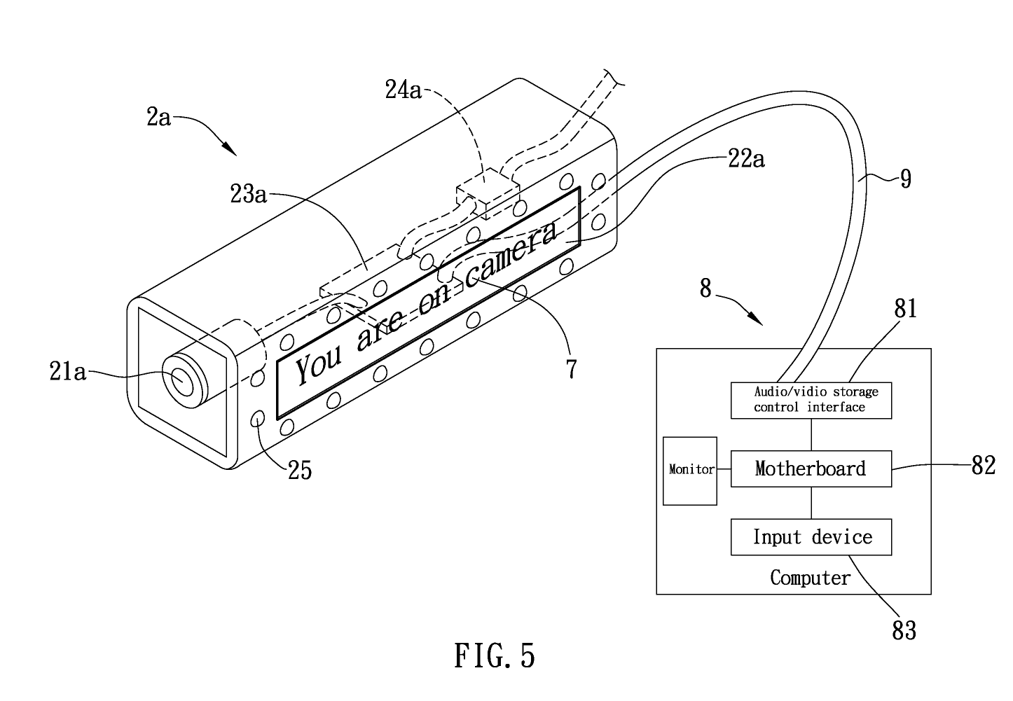

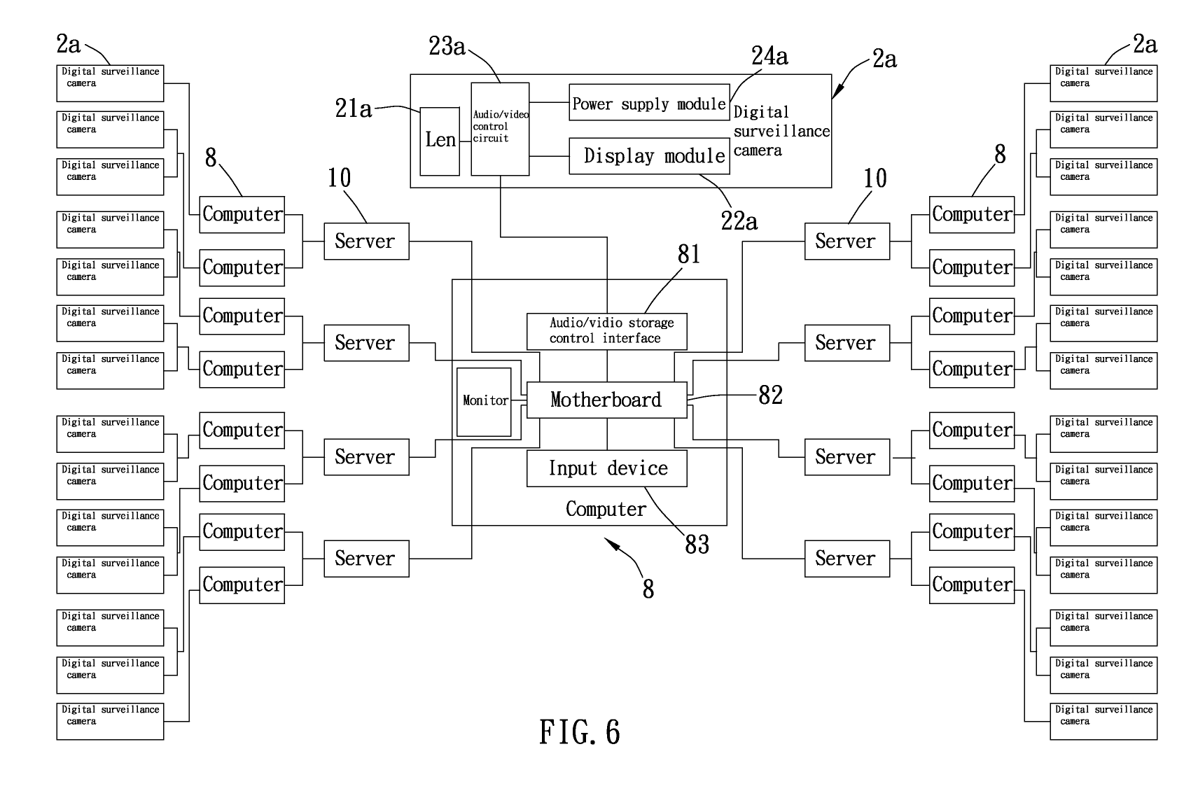

In a third embodiment, as shown in FIGS. 5 and 6, FIG. 5 is a schematic perspective view of the third embodiment of the present invention, FIG. 6 is a block flow chart showing the third embodiment of the present invention.

As shown in the figures, the device for remotely changing display content of a display module in a surveillance camera, including:

at least one digital surveillance camera 2a having a lens 21a, a display module 22a, an audio/video control circuit 23a and a power supply module 24a, wherein the lens 21a and the display module 22a are electrically connected to the audio/video control circuit 23a respectively;

a computer 8 having a motherboard and an audio/video storage control interface 81, the audio/video storage control interface 81 electrically connected to the motherboard 82; and

at least one transmission line 9 having two ends, one end thereof electrically connected to the audio/video control circuit 23a of the at least one surveillance camera 2a, the other end thereof electrically connected to the audio/video storage control interface 81 of the computer 8,

wherein, the display content 7 displayed on the display module 22a can be changed by data input from the input device 83 of the computer 8.

In addition, the motherboard 82 of the computer 8 can also be electrically connected to a multiplicity of servers 10, then the multiplicity of servers 10 electrically connected to a multiplicity of computers 8, then the multiplicity of computers 8 electrically connected to a multiplicity of digital surveillance cameras 2a, so as to form a system of large regional digital surveillance cameras 2a.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A device for remotely changing display content of a display module in a surveillance camera, comprising:
at least one surveillance camera having a lens, a display module, an audio/video control circuit and a power supply module, wherein the lens and the display module are electrically connected to the audio/video control circuit respectively;
a digital audio/video storage device having a host control circuit and a display control module, wherein the display control module has a port having two ends, one end of the port electrically connected to the display control module, and the other end of the port electrically connected to an input device;
at least one first transmission line having two ends, one end thereof electrically connected to the audio/video control circuit of the at least one surveillance camera, the other end thereof electrically connected to the host control circuit of the digital audio/video storage device; and
a second transmission line having two ends, one end thereof electrically connected to the audio/video control circuit of the at least one surveillance camera, the other end thereof electrically connected to the display control module of the digital audio/video storage device,
wherein, the display content displayed on the display module can be changed by data input from the input device.

2. The device as claimed in claim 1, wherein at least one side of the surveillance camera has at least one light-emitting element.

3. The device as claimed in claim 1, wherein the port is one selected from the following group consisting of: USB slot, PS2 slot, dual slots and triple slots.

4. The device as claimed in claim 1, wherein the input device is one selected from the following group consisting of: mobile phones, computers, personal digital assistants (PDAs), mouse, and keyboard.

5. The device as claimed in claim 1, wherein the display module is one selected from the following group consisting of: a LCD screen, an OLED display screen, an LED display screen.

6. The device as claimed in claim 1, wherein the display content is one selected from the following group consisting of: text, graphics, text and graphics.

7. A device for remotely changing display content of a display module in a surveillance camera, comprising:
at least one surveillance camera having a lens, a display module, an audio/video control circuit and a power supply module, wherein the lens and the display module are electrically connected to the audio/video control circuit respectively, the audio/video control circuit having a radio transceiver circuit so as to transmit image signals captured by the lens and receive an input data via the radio transceiver circuit;
a digital audio/video storage device having a host control circuit and a display control module, wherein the host control circuit has a radio receiver circuit for receiving image signals from the audio/video control circuit, and the display control module having a port with two ends, one end of the port electrically connected to the display control module and the other end of the port electrically connected to an input device, the display control module having a radio transmitter circuit for transmitting display data input by the input device to the radio transceiver circuit of the audio/video control circuit;
wherein, the display content displayed on the display module can be changed by data input from the input device via radio transmission.

8. The device as claimed in claim 7, wherein at least one side of the surveillance camera has at least one light-emitting element.

9. The device as claimed in claim 7, wherein the port is one selected from the following group consisting of: USB slot, PS2 slot, dual slots and triple slots.

10. The device as claimed in claim 7, wherein the input device is one selected from the following group consisting of: mobile phones, computers, personal digital assistants (PDAs), mouse, and keyboard.

11. A device for remotely changing display content of a display module in a surveillance camera, comprising:
at least one surveillance camera having a lens, a display module, an audio/video control circuit and a power supply module, wherein the lens and the display module are electrically connected to the audio/video control circuit respectively;
a computer having a motherboard and an audio/video storage control interface, the audio/video storage control interface electrically connected to the motherboard; and
at least one transmission line having two ends, one end thereof electrically connected to the audio/video control circuit of the at least one surveillance camera, the other end thereof electrically connected to the audio/video storage control interface of the computer, wherein, the display content displayed on the display module can be changed by data input from the input device of the computer.

12. The device as claimed in claim 11, wherein at least one side of the surveillance camera has at least one light-emitting element.
